(19) United States
(12) Patent Application Publication
(10) Pub. No.: US 2013/0163875 A2
(43) Pub. Date: Jun. 27, 2013

(54) IMAGE RECOGNITION METHOD AND COMPUTER PROGRAM PRODUCT THEREOF

(71) Applicants: Ching-Hao LAI, Taichung County (TW); Chia-Chen YU, Taoyuan City, Taoyuan County (TW); Wei-Yi TUNG, Yongkang City, Tainan County (TW)

(72) Inventors: Ching-Hao LAI, Taichung County (TW); Chia-Chen YU, Taoyuan City, Taoyuan County (TW); Wei-Yi TUNG, Yongkang City, Tainan County (TW)

(73) Assignee: INSTITUTE FOR INFORMATION INDUSTRY, Taipei (TW)

(21) Appl. No.: 13/154,194

(22) Filed: Jun. 6, 2011

(30) Foreign Application Priority Data
Dec. 6, 2010 (TW) 099142348

(51) Int. Cl. G06K 9/46

(52) U.S. Cl. 382/190

(57) ABSTRACT

First, the image recognition method of the present invention transforms a first Cartesian coordinate value of a first image and a second Cartesian coordinate value of a second image in the Cartesian coordinate system into a first polar coordinate value and a second polar coordinate value in a polar coordinate system, respectively. Afterwards, the image recognition method adjusts the first image and the second image to multiple scales based on a radial coordinate of the polar coordinate system, and obtains a plurality of first local description values and a plurality of second local description values by analyzing the first interest points of the first image and the second interest points of the second image on the multiple scales, respectively. Finally, by intercomparing the first local description values and the second local description values, a matching feature between the first image and the second image is recognized.

This application claims the benefit of priority based on Taiwan Patent Application No. 099142348 filed on Dec. 6, 2010, which is hereby incorporated by reference in its entirety.

### FIELD

The present invention relates to an image recognition method and a computer program product thereof. More particularly, the image recognition method of the present invention extracts and recognizes matching features among a plurality of images by transforming the information of the images into a polar coordinate system, adjusting the images to multiple scales in the polar coordinate system and analyzing the images on multiple scales.

### BACKGROUND

Due to the quick developments of science and technology, more and more images are now stored into electronic files in a digitalized form, for example, digital movies and digital photos. Computers and the Internet mechanisms are widespreadly used and thus the amount of such electronic image files have increased and been dispersed more readily. To search for and sort similar images (e.g., photos having images of the same person), many scholars and service providers have currently analyzed images through image recognition technologies to recognize similar features and, consequently, correlations between the images.

According to conventional image recognition technologies, the pixels of the images are represented in a Cartesian coordinate system and adjusted to multiple scales in the Cartesian coordinate system to retrieve interest points of each image on the multiple scales. Accordingly, the correlations of the images can be determined by comparing the interest points of these images to recognize similar features therebetween.

According to conventional image recognition technologies, each image is adjusted to multiple scales in the Cartesian coordinate system. As a result, a great amount of coordinate values are needed to represent the images that have been adjusted to scale. For example, an image with 16 (4×4) pixels have 4×4 coordinate values in the Cartesian coordinate system, i.e., 4 X-coordinate values and 4 Y-coordinate values must be used to represent the 16 pixels of the image. When the image is adjusted in scale to be magnified by 10 times, 40×40 coordinate values must be used to represent the 1600 pixels of the adjusted image. The excessively large number of pixels that are needed to be used for analysis leads to poor recognition efficiency of the conventional image recognition technologies.

In view of the above requirements, efforts still have to be made in this field to improve the efficiency of image recognition.

### SUMMARY

An objective of the present invention is to provide an image recognition method. The image recognition method transforms the information of a plurality of images from a Cartesian coordinate system into a polar coordinate system. The images therefore can be adjusted to multiple scales based on only the radial coordinate of the polar coordinate system. The present invention can significantly reduce the number of necessary pixels in the analysis, thereby improving the recognition efficiency.

To accomplish the aforesaid objective, the present invention discloses an image recognition method, which comprises the following steps:

(a) reading a first image, wherein the first image comprises a plurality of first pixels, each of which has a first Cartesian coordinate value in a Cartesian coordinate system and a first pixel value;

(b) transforming each of the first Cartesian coordinate values into a first polar coordinate value in a polar coordinate system, wherein the polar coordinate system comprises a radial coordinate and an angular coordinate;

(c) choosing a first scale value from a first scale value set and, with the first scale value, performing a first scaling operation on the first polar coordinate values and the first pixel values based on the radial coordinate to generate a first scaled image, wherein the first scaled image comprises a plurality of first scaled pixels, each of which has a first scaled polar coordinate value in the polar coordinate system and a first scaled pixel value;

(d) retrieving a plurality of first interest points from the first scaled pixels of the first scaled image by using a Corner Detection method, wherein each of the first interest points comprises a part of the first scaled pixels;

(e) accumulating the first scaled pixel values of the first scaled pixels of each of the first interest points, based on the angular coordinate, to normalize the first scaled polar coordinate values of the first scaled pixels of each of the first interest points;

(f) generating a first local description value set of each of the first interest points according to the first scaled polar coordinate values and the first scaled pixel values of the first scaled pixels of each of the first interest points;

(g) storing the first local description value sets into a first database;

(h) repeating the step (c) through the step (g) by choosing another first scale value from the first scale value set to perform a first scaling operation with the another first scale value to generate a first local description value set of each of the first interest points corresponding to the another first scale value and store the first local description value set into the first database, until all the first scale values of the first scale value set have been chosen;

(i) reading a second image, wherein the second image comprises a plurality of second pixels, each of which has a second Cartesian coordinate value in the Cartesian coordinate system and a second pixel value;

(j) transforming each of the second Cartesian coordinate values into a second polar coordinate value in the polar coordinate system;

(k) choosing a second scale value from a second scale value set and, with the second scale value, performing a second scaling operation on the second polar coordinate values and the second pixel values based on the radial coordinate to generate a second scaled image, wherein the second scaled image comprises a plurality of second scaled pixels, each of which has a second scaled polar coordinate value of the polar coordinate system and a second scaled pixel value;

(l) retrieving a plurality of second interest points from the second scaled pixels of the second scaled image by using a Corner Detection method, wherein each of the second interest points comprises a part of the second scaled pixels;

(m) accumulating the second scaled pixel values of the second scaled pixels of each of the second interest points, based on the angular coordinate, to normalize the second scaled polar coordinate values of the second scaled pixels of each of the second interest points;

(n) generating a second local description value set of each of the second interest points according to the second scaled polar coordinate values and the second scaled pixel values of the second scaled pixels of each of the second interest points;

(o) storing the second local description value sets into a second database;

(p) repeating the step (k) through the step (o) by choosing another second scale value from the second scale value set to perform a second scaling operation with the another second scale value to generate a second local description value set of each of the second interest points corresponding to the another second scale value and store the second local description value set into the second database, until all the second scale values of the second scale value set have been chosen; and

(q) intercomparing the first local description value sets of the first database with the second local description value sets of the second database to recognize a matching feature between the first image and the second image.

To accomplish the aforesaid objective, the present invention further discloses a computer program product comprising a non-transitory computer readable medium storing a program for the aforesaid image recognition method. When the program is loaded into a computer with a microprocessor, the image recognition method can be executed and accomplished by the microprocessor.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A to FIG. 1C illustrate a flowchart of an embodiment of the present invention;

FIGS. 2A and 2B are schematic views illustrating the conversion of coordinates according to the embodiment of the present invention; and

FIG. 3 is a schematic view illustrating the recognition of matching features between the first image 1 and the second image 2 shown in FIG. 2A and FIG. 2B, respectively.

### DESCRIPTION OF THE PREFERRED EMBODIMENT

The descriptions of the embodiments below are only for purposes of illustration rather than limitation. It should be appreciated that in the following embodiments and attached drawings, elements unrelated to the present invention are omitted from depiction; and the dimensional relationships among individual elements in the attached drawings are illustrated only for ease of understanding, but not to limit the actual scale.

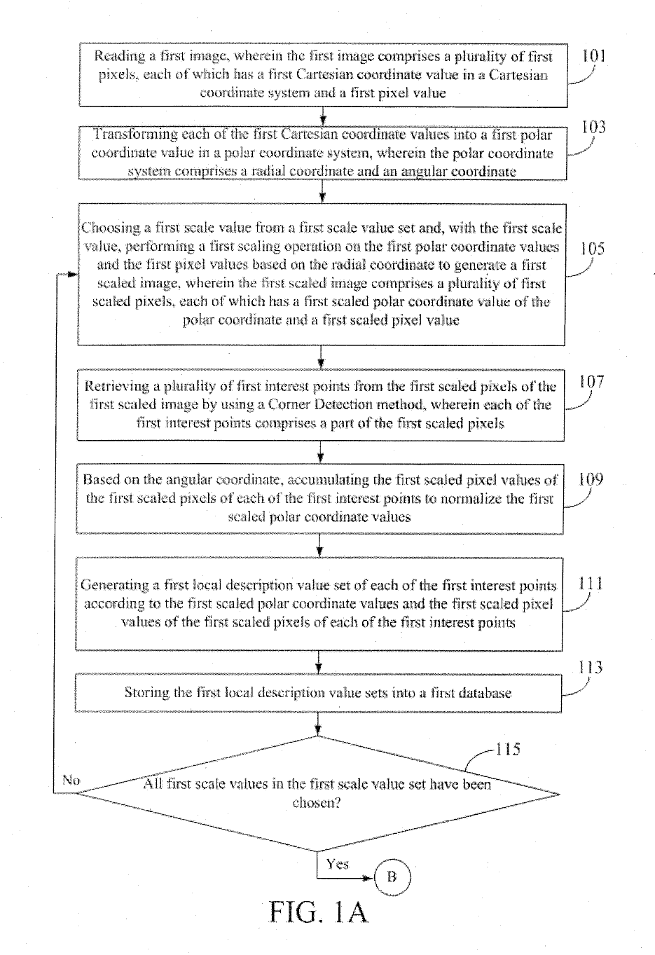

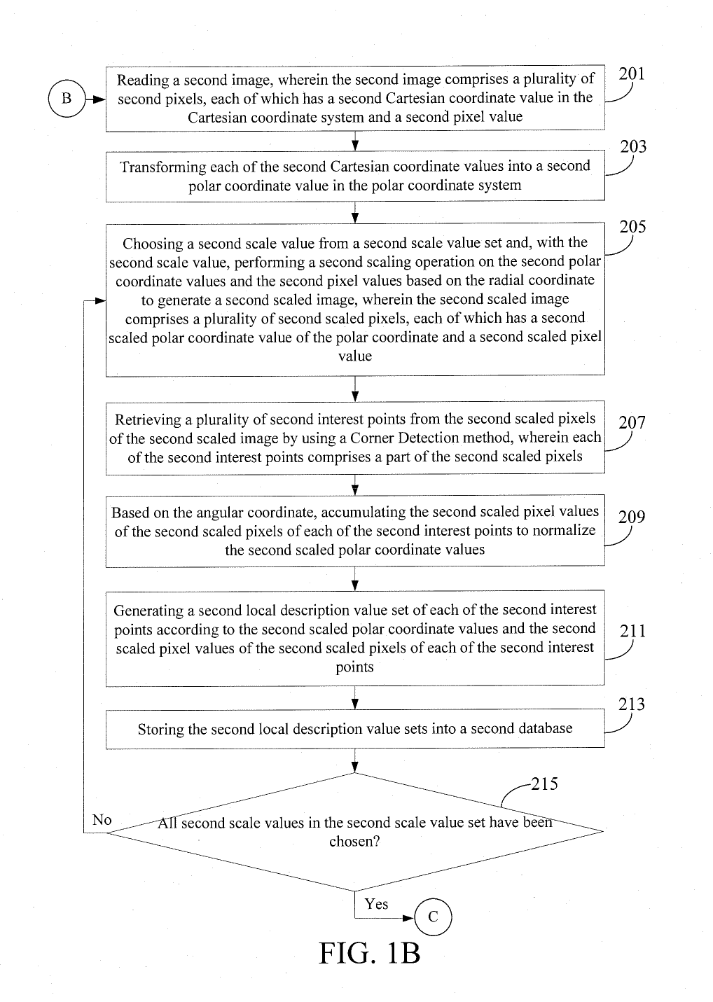

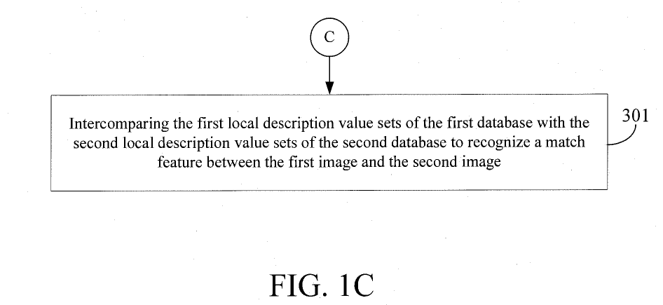

An embodiment of the present invention discloses an image recognition method, a flowchart of which is shown in FIG. 1A to FIG. 1C. In particular, the image recognition method described in this embodiment may be implemented by a computer program product comprising a non-transitory computer readable medium storing a program. When the program is loaded onto a computer with a microprocessor and a plurality of codes contained in the program is executed, the image recognition method of this embodiment can be accomplished. The aforesaid computer readable medium may be a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

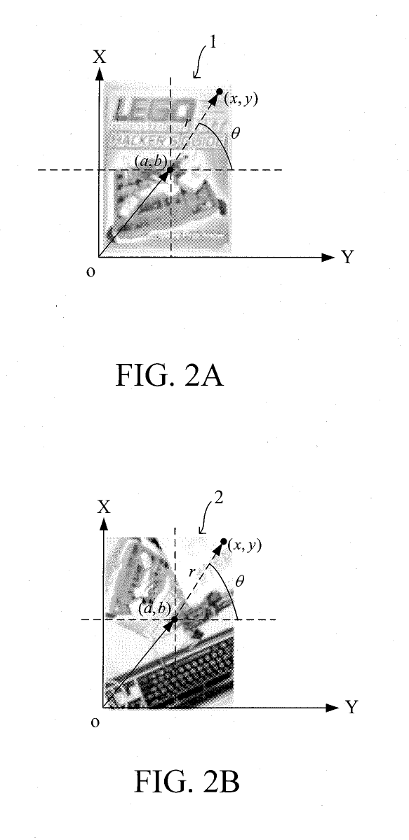

A first image is read through step 101. The first image comprises a plurality of first pixels, each of which has a first Cartesian coordinate value in a Cartesian coordinate system and a first pixel value (e.g., a gray scale value, an RGB value or some other value used to represent a pixel color). Step 103 is then executed to transform each of the first Cartesian coordinate values into a first polar coordinate value in a polar coordinate system. The polar coordinate system comprises a radial coordinate and an angular coordinate. For example, as shown in FIG. 2A, assume that a first pixel located at the center of a first image 1 has a first Cartesian coordinate value of (a, b) in the Cartesian coordinate system, where a is an X-coordinate value in the Cartesian coordinate system and b is a Y-coordinate value in the Cartesian coordinate system, and the origin O is a first pixel located at the bottom left corner of the first image. The first polar coordinate value (r, θ) in the polar coordinate system converted from the first Cartesian coordinate value (x, y) of any first pixel of the first image 1 in the Cartesian coordinate system can be derived from Formula 1 and Formula 2 below:

$$\begin{matrix}r = \sqrt{{( x - a )}^{2} + {( y - b )}^{2}} & ( Formula 1 ) \\ θ = \{ \begin{matrix}{tan}^{- 1} ( \frac{( y - b )}{( x - a )} ) if ( x - a ) > 0 and ( y - b ) > 0 \\ {tan}^{- 1} ( \frac{( y - b )}{( x - a )} ) + 2 π if ( x - a ) > 0 and ( y - b ) < 0 \\ {tan}^{- 1} ( \frac{( y - b )}{( x - a )} ) + π if ( x - a ) < 0 \\ \frac{π}{2} if ( x - a ) = 0 and ( y - b ) > 0 \\ \frac{3 π}{2} if ( x - a ) = 0 and ( y - b ) < 0 \\ 0 if ( x - a ) = 0 and ( y - b ) = 0 \end{matrix} & ( Formula 2 )\end{matrix}$$

where r represents a radial coordinate value and θ represents an angular coordinate value.

Step 105 is then executed to choose a first scale value from a first scale value set and, with the first scale value, perform a first scaling operation on the first polar coordinate values and the first pixel values based on the radial coordinate to generate a first scaled image. The first scaled image comprises a plurality of first scaled pixels, each of which has a first scaled polar coordinate value in the polar coordinate system and a first scaled pixel value.

In step 105, the first image is upscaled and downscaled based on the radial coordinate, and the first scale value set comprises n₁+n₂+1 first scale values (including the original scale), which are 2⁻ⁿ^{₁} to 2ⁿ^{₂} respectively. For example, if the first image, based on the radial coordinate, is upscaled by factors of 2, 4, 8 and 16 and downscaled by factors of 2 and 4, then n₁=2 and n₂=4; i.e., the first scale value set comprises 7 first scale values. Furthermore, if the original first image has 128 first pixels, then the first scaled image that is upscaled by a factor of 2 based on the radial coordinate has 256 first scaled pixels.

Among the 256 first scaled pixels, 128 first scaled pixels have first scaled pixel values that are the same as the first pixel values of the original 128 first pixels while the other 128 first scaled pixels have first scaled pixel values obtained through interpolation and extrapolation. On the other hand, the first scaled image downscaled by a factor of 2 has 64 first scaled pixels, among which 64 first scaled pixels have first scaled pixel values that are the same as the first pixel values of 64 out of the original 128 first pixels.

In other words, the downscaling operation is to retrieve, at an equal interval, 64 first pixels from the original 128 first pixels for use as the first scaled pixels. Because the upscaling and downscaling operations can be accomplished through a number of algorithms and are well known to those persons having ordinary skill in the art, no further description will be made herein.

It shall be noted that unlike conventional image recognition methods, the image recognition method of the present invention adopts a polar coordinate system, such that when an image with 16 (4×4) pixels is upscaled by a factor of 10 based on the radial coordinate, only the number of radial coordinate values needs to be increased without having to increase the number of angular coordinate values. The present invention scales an image only based on a one-dimensional coordinate (a radial coordinate); i.e., 40×4 coordinate values are used to represent 160 pixels of the image that is upscaled by a factor of 10 based on the radial coordinate.

As compared with conventional image recognition methods, the image recognition method of the present invention is able to use a fewer number of pixels for analysis. On the other hand, as compared with scaling an image based on a one-dimensional coordinate (i.e., the X-coordinate or the Y-coordinate) in a Cartesian coordinate system, scaling an image based on a radial coordinate in a polar coordinate system can make the image appear to be more uniform and may be regarded as scaling the image based on two dimensional coordinates in a Cartesian coordinate system.

After step 105 where the first scale value is chosen and the first scaling operation according to the first scaling value is executed, step 107 is executed to retrieve a plurality of first interest points from the first scaled pixels of the first scaled image by using a Corner Detection method. Each of the first interest points comprises a part of the first scaled pixels. Specifically, step 107 is executed to find out parts of the first scaled pixels from the first scaled pixels for use as the first interest point through the Corner Detection method, where the variation among the first scaled pixel values of the parts of the first scale pixels is great at each angle. The first scaled image may have one or more interest points, each of which comprises a plurality of first scaled pixels, e.g., 16 (4×4) consecutive first scaled pixels. It shall be appreciated that the corner detection method adopted in the present invention may be the Harris Corner Detection method, Moravec Corner Detection method or some other Corner Detection methods commonly used in the art.

Step 109 is then executed to accumulate the first scaled pixel values of the first scaled pixels of each of the first interest point based on the angular coordinate so as to normalize the first scaled polar coordinate values. Hereinbelow, a mathematical expression will be used to represent the normalization process of the present invention. A first interest point with 16 (4×4) pixels is represented by a matrix F₁ below:

$${F}_{1} = [ \begin{matrix}{F}_{{θ}_{1} , {R}_{1}} & {F}_{{θ}_{1} , {R}_{2}} & {F}_{{θ}_{1} , {R}_{3}} & {F}_{{θ}_{1} , {R}_{4}} \\ {F}_{{θ}_{2} , {R}_{1}} & {F}_{{θ}_{2} , {R}_{2}} & {F}_{{θ}_{2} , {R}_{3}} & {F}_{{θ}_{2} , {R}_{4}} \\ {F}_{{θ}_{3} , {R}_{1}} & {F}_{{θ}_{3} , {R}_{2}} & {F}_{{θ}_{3} , {R}_{3}} & {F}_{{θ}_{3} , {R}_{4}} \\ {F}_{{θ}_{4} , {R}_{1}} & {F}_{{θ}_{4} , {R}_{2}} & {F}_{{θ}_{4} , {R}_{3}} & {F}_{{θ}_{4} , {R}_{4}}\end{matrix} ] ,$$

where each element of the matrix F₁ represents a first scaled pixel value of a scaled pixel which has an angular coordinate value of θₘ and a radial coordinate value of rₙ. Elements in each row of the matrix F₁ are summed up to represent the sum of the first scaled pixel values at the angular coordinate θₘ. Finally, a row of which the sum is greatest (it is assumed to be the second row herein; i.e., the first scaled pixel values at the angular coordinate θ₂ give the greatest sum) is shifted to the last row (i.e., the fourth row) of the matrix F₁:

$${F}_{1} = {PF}_{1} = [ \begin{matrix}{F}_{{θ}_{3} , {R}_{1}} & {F}_{{θ}_{3} , {R}_{2}} & {F}_{{θ}_{3} , {R}_{3}} & {F}_{{θ}_{3} , {R}_{4}} \\ {F}_{{θ}_{4} , {R}_{1}} & {F}_{{θ}_{4} , {R}_{2}} & {F}_{{θ}_{4} , {R}_{3}} & {F}_{{θ}_{4} , {R}_{4}} \\ {F}_{{θ}_{1} , {R}_{1}} & {F}_{{θ}_{1} , {R}_{2}} & {F}_{{θ}_{1} , {R}_{3}} & {F}_{{θ}_{1} , {R}_{4}} \\ {F}_{{θ}_{2} , {R}_{1}} & {F}_{{θ}_{2} , {R}_{2}} & {F}_{{θ}_{2} , {R}_{3}} & {F}_{{θ}_{2} , {R}_{4}}\end{matrix} ] ,$$

where, the matrix P represents a permutation matrix. The first scaled polar coordinate values of the first scaled pixels of the first interest point are normalized through the aforesaid operations.

In other embodiments, the matrix F₁ may be multiplied with a Gaussian weight vector g before summing up the elements for each row of the matrix F₁; i.e., the first scaled pixel values with different radial coordinate values are multiplied with a plurality of Gaussian weights respectively before being summed up.

Step 111 is executed after step 109 to generate a first local description value set of each of the first interest points according to the first scaled polar coordinate values and the first scaled pixel values of the first scaled pixels of each of the first interest points. Step 111 is executed to compare the first scaled pixel values of the first scaled pixels of each of the first interest points to generate the first local description value set of each of the first interest points.

Taking the normalized matrix F₁ as an example, by subtracting the first scaled pixel value (e.g., F_{θ}_{₂}_{,R}_{₁}) of the first scaled pixel of the first interest point from the first scaled pixel value (e.g., F_{θ}_{₁}_{,R}_{₁}, F_{θ}_{₁}_{,R}_{₂} and F_{θ}_{₂}_{,R}_{₂}) of a neighboring first scaled pixel, three difference values of F_{θ}_{₁}_{,R}_{₁}−F_{θ}_{₂}_{,R}_{₁}, F_{θ}_{₁}_{,R}_{₂}−F_{θ}_{₂}_{,R}_{₁} and F_{θ}_{₂}_{,R}_{₂}−F_{θ}_{₂}_{,R}_{₁} (i.e., the first local description values) are obtained and each of the difference values is represented by a 1-bit value. Hence, the first local description value set of the first interest point with 16(4×4) scaled pixels has 4×3×3 bits of first local description values (difference values between the fourth column F_{θ}_{₁}_{,R}_{₄}, F_{θ}_{₂}_{,R}_{₄}, F_{θ}_{₃}_{,R}_{₄}, F_{θ}_{₄}_{,R}_{₄} and other elements in the matrix F₁ shall be excluded). In other words, if the scaled image has i first interest points, it will have i×4×3×3 bits of first local description values.

After the first local description value set of each of the first interest points is generated, step 113 is executed to store the first local description value sets into a first database. Step 115 is then executed to determine whether all first scale values in the first scale set have been chosen. If there is any first scale value that has not yet been chosen, the process returns back to step 105 to choose another first scale value from the first scale value set. By this way, the first scaling operation is performed according to another first scale value to generate the first local description value set of each of the first interest points corresponding to the another first scale value, and store them into the first database.

Steps 105 to 113 are repeated until all the first scale values in the first scale set have been chosen. In other words, if the first scale values include upscale values of 2, 4, 8 and 16 as well as downscale values of 2 and 4, then the steps 105 through 115 are repeated to generate the first local description value sets of each of the first interest points corresponding to the first scale values and store the first local description value sets into the first database.

If all the first scale values have been chosen, this means that all data necessary for analyzing the first image have been stored in the first database. Step 201 is then executed to read a second image for preparation of generating second local description value sets of the second image. The second image comprises a plurality of second pixels, each of which has a second Cartesian coordinate value in the Cartesian coordinate system and a second pixel value. It shall be noted that as operations made on the second image are substantially the same as those made on the first image, identical details will not be set forth again herein.

Step 203 is subsequently executed to transform each of the second Cartesian coordinate values into a second polar coordinate value in the polar coordinate system. As shown in FIG. 2B, assume that a second pixel located at the center of a second image 2 has a second Cartesian coordinate value of (a, b) in the Cartesian coordinate system, where a is an X-coordinate value in the Cartesian coordinate system and b is a Y-coordinate value in the Cartesian coordinate system, and the origin O is a second pixel located at the left bottom corner of the second image. The second polar coordinate values (r, θ) in the polar coordinate system converted from the second Cartesian coordinate values (x, y) of any second pixel of the second image 2 in the Cartesian coordinate system can be derived from Formula 1 and Formula 2 above.

Step 205 is executed to choose a second scale value from a second scale value set and, based on the radial coordinate, a second scaling operation is made on the second polar coordinate values and the second pixel values according to the second scale value to generate a second scaled image. The second scaled image comprises a plurality of second scaled pixels, each of which has a second scaled polar coordinate value in the polar coordinate system and a second scaled pixel value. In practical operation, the second scale value set may be identical to the first scale value set, or comprise more upscale values and downscale values.

Next, step 207 is executed to retrieve a plurality of second interest points from the second scaled pixels of the second scaled image by using the Corner Detection method. Each of the second interest points comprises a part of the second scaled pixels. Step 209 is then executed to accumulate the second scaled pixel values of the second scaled pixels of each of the second interest points based on the angular coordinate so as to normalize the second scaled polar coordinate values. Similar to step 109, step 209 is provided to generate a normalized matrix F₂ for the second scaled polar coordinate values of the second scaled pixels of a second interest point.

Step 211 is executed to generate a second local description value set of each of the second interest points according to the second scaled polar coordinate values and the second scaled pixel values of the second scaled pixels of each of the second interest points. Step 213 is executed to store the second local description value sets into a second database. Similarly, step 115 is executed to determine whether all second scale values in the second scale set have been chosen. If there is any second scale value that has not yet been chosen, the process returns back to step 205 to choose another second scale value from the second scale set.

A second scaling operation is therefore performed according to the another second scale value to generate a second local description value set of each of the second interest points corresponding to the another second scale value, and store them into the second database. Steps 205 to 213 are repeated until all the second scale values in the second scale set have been chosen.

If all the second scale values have been chosen, it means that all data necessary for analyzing the second image have been stored in the second database. Step 301 is finally executed to inter-compare the first local description value sets of the first database with the second local description value sets of the second database to recognize a matching feature between the first image and the second image.

In step 301, the Hamming distances between the first local description value sets of the first database and the second local description value sets of the second database are calculated. When the Hamming distance between the first local description value set of a first interest point and a second local description value set of a second interest point is smaller than the threshold, a matching feature between the first image and the second image is recognized.

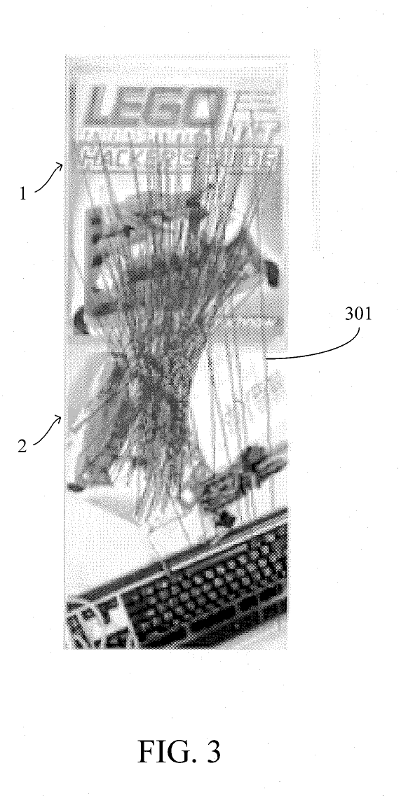

As shown in FIG. 3, by applying the image recognition method of the present invention to the first image 1 of FIG. 2A and the second image 2 of FIG. 2B, several match features between the first image 1 and the second image 2 are recognized. The lines 301 in FIG. 3 are schematically used to connecting the part of the interest points of the first image 1 with the part of the interest points of the second image 2.

Further, in calculating the Hamming distances, different weighting functions (e.g., linear weighting functions and exponent weighting functions) may be used for the first local description value set of the first interest point and the second local description value set of the second interest point so that the local description values corresponding to different radial coordinate values r have different weights.

It shall be particularly noted that in this embodiment, the terms “first” and “second” are used to refer to different images. In other embodiments, however, the image recognition method of the present invention may further recognize more than two images. In other words, those persons having ordinary skill in the art may readily know how the image recognition method of the present invention recognizes more than two images based on the aforesaid embodiment and thus no further description will be made herein.

Moreover, steps 101 through 115 may be swapped with steps 201 through 215; i.e., the present invention is not limited by whether the first local description value sets or the second local description value sets are generated first and stored into the respective database. The present invention is certainly not limited to calculate the bit differences between the first local description value sets and the second local description value sets by using the Hamming distance approach; rather, other approaches commonly used in the art to calculate bit differences may also be used in the present invention to produce the same effect.

According to the above descriptions, the image recognition method of the present invention has pixels of an image represented in a polar coordinate system and adjusts the scale of the image based on the radial coordinate in the polar coordinate system. As compared with conventional image recognition methods, the present invention can reduce the number of pixels that needs to be used for analysis of an upscaled image, thus reducing the amount of operations necessary for image recognition and improving the efficiency of image recognition.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An image recognition method, comprising the following steps of:
(a) reading a first image, wherein the first image comprises a plurality of first pixels, and each of the first pixels has a first Cartesian coordinate value in a Cartesian coordinate system and a first pixel value;
(b) transforming each of the first Cartesian coordinate values into a first polar coordinate value in a polar coordinate system, wherein the polar coordinate system comprises a radial coordinate and an angular coordinate;
(c) choosing a first scale value from a first scale value set and performing a first scaling operation on the first polar coordinate values and the first pixel values based on the radial coordinate to generate a first scaled image, wherein the first scaled image comprises a plurality of first scaled pixels, and each of the first scaled pixels has a first scaled polar coordinate value of the polar coordinate system and a first scaled pixel value;
(d) retrieving a plurality of first interest points from the first scaled pixels of the first scaled image by using a Corner Detection method, wherein each of the first interest points comprises a part of the first scaled pixels;
(e) accumulating the first scaled pixel values of the first scaled pixels of each of the first interest points, based on the angular coordinate, to normalize the first scaled polar coordinate values of the first scaled pixels of each of the first interest points;
(f) generating a first local description value set of each of the first interest points according to the first scaled polar coordinate values and the first scaled pixel values of the first scaled pixels of each of the first interest points;
(g) storing the first local description value sets into a first database;
(h) repeating the step (c) through the step (g) by choosing another first scale value from the first scale value set to perform a first scaling operation with the another first scale value to generate a first local description value set of each of the first interest points corresponding to the another first scale value and store the first local description value set into the first database, until all the first scale values of the first scale value set have been chosen;
(i) reading a second image, wherein the second image comprises a plurality of second pixels, and each of the second pixels has a second Cartesian coordinate value in the Cartesian coordinate system and a second pixel value;
(j) transforming each of the second Cartesian coordinate values into a second polar coordinate value in the polar coordinate system;
(k) choosing a second scale value from a second scale value set and, with the second scale value, performing a second scaling operation on the second polar coordinate values and the second pixel values based on the radial coordinate to generate a second scaled image, wherein the second scaled image comprises a plurality of second scaled pixels, and each of the second scaled pixels has a second scaled polar coordinate value of the polar coordinate system and a second scaled pixel value;
(l) retrieving a plurality of second interest points from the second scaled pixels of the second scaled image by using a Corner Detection method, wherein each of the second interest points comprises a part of the second scaled pixels;
(m) accumulating the second scaled pixel values of the second scaled pixels of each of the second interest points, based on the angular coordinate, to normalize the second scaled polar coordinate values of the second scaled pixels of each of the second interest points;
(n) generating a second local description value set of each of the second interest points according to the second scaled polar coordinate values and the second scaled pixel values of the second scaled pixels of each of the second interest points;
(o) storing the second local description value sets into a second database;
(p) repeating the step (k) through the step (o) by choosing another second scale value from the second scale value set to perform a second scaling operation with the another second scale value to generate a second local description value set of each of the second interest points corresponding to the another second scale value and store the second local description value set into the second database, until all the second scale values of the second scale value set have been chosen;
(q) intercomparing the first local description value sets of the first database with the second local description value sets of the second database to recognize a matching feature between the first image and the second image.

2. The image recognition method as claimed in claim 1, wherein the first scale value set comprises n₁+n₂+1 first scale values, and the first scale values are 2⁻ⁿ^{₁} to 2ⁿ^{₂}, and wherein the second scale value set comprises m₁+m₂+1 second scale values, and the second scale values are 2^{-m}^{₁}⁻ to 2^{m}^{₂}.

3. The image recognition method as claimed in claim 1, wherein the step (e) further comprises the following steps of:
(e1) determining a first angle, based on the angular coordinate, corresponding to a greatest accumulated value of the first scaled pixel values of each of the first interest points; and
(e2) adjusting the first scaled polar coordinate values of the first scaled pixels of each of the first interest points, according to the first angle corresponding to each of the first interest points, to normalize the first scaled polar coordinate values;
and wherein the step (m) further comprises the following steps of:
(m1) determining a second angle, based on the angular coordinate, corresponding to a greatest accumulated value of the second scaled pixel values of each of the second interest points; and
(m2) adjusting the second scaled polar coordinate values of the second scaled pixels of each of the second interest points, according to the second angle corresponding to each of the second interest points, to normalize the second scaled polar coordinate values.

4. The image recognition method as claimed in claim 1, wherein the step (e) further comprises the following step of:
(e3) before accumulating the first scaled pixel values, multiplying the first scaled pixel values of the first scaled pixels of each of the first interest points with a plurality of Gaussian weights;
and wherein the step (m) further comprises the following step of:
(m3) before accumulating the second scaled pixel values, multiplying the second scaled pixel values of the second scaled pixels of each of the second interest points with the Gaussian weights.

5. The image recognition method as claimed in claim 1, wherein the step (f) further comprises the following step of:
(f1) comparing the first scaled pixel values of the first scaled pixels of each of the first interest points to generate the first local description value set of each of the first interest points;
and wherein the step (n) further comprises the following step of:
(n1) comparing the second scaled pixel values of the second scaled pixels of each of the second interest points to generate the second local description value set of each of the second interest points.

6. A computer program product, comprising a non-transitory computer readable medium storing a program for a image recognition method, wherein when the program is loaded into a computer and executed, the image recognition method is accomplished, the program comprising:
a code A for reading a first image, wherein the first image comprises a plurality of first pixels, and each of the first pixels has a first Cartesian coordinate value in a Cartesian coordinate system and a first pixel value;
a code B for transforming each of the first Cartesian coordinate values into a first polar coordinate value in a polar coordinate system, wherein the polar coordinate system comprises a radial coordinate and an angular coordinate;
a code C for choosing a first scale value from a first scale value set and, with the first scale value, performing a first scaling operation on the first polar coordinate values and the first pixel values based on the radial coordinate to generate a first scaled image, wherein the first scaled image comprises a plurality of first scaled pixels, and each of the first scaled pixels has a first scaled polar coordinate value of the polar coordinate system and a first scaled pixel value;
a code D for retrieving a plurality of first interest points from the first scaled pixels of the first scaled image by using a Corner Detection method, wherein each of the first interest points comprises a part of the first scaled pixels;
a code E for accumulating the first scaled pixel values of the first scaled pixels of each of the first interest points, based on the angular coordinate, to normalize the first scaled polar coordinate values of the first scaled pixels of each of the first interest points;
a code F for generating a first local description value set of each of the first interest points according to the first scaled polar coordinate values and the first scaled pixel values of the first scaled pixels of each of the first interest points;
a code G for storing the first local description value sets into a first database;
a code H for repeating execution of the code C through the code G by choosing another first scale value from the first scale value set to perform a first scaling operation with the another first scale value to generate a first local description value set of each of the first interest points corresponding to the another first scale value and store the first local description value set into the first database, until all the first scale values of the first scale value set have been chosen;
a code I for reading a second image, wherein the second image comprises a plurality of second pixels, and each of the second pixels has a second Cartesian coordinate value in the Cartesian coordinate system and a second pixel value;
a code J for transforming each of the second Cartesian coordinate values into a second polar coordinate value in the polar coordinate system;
a code K for choosing a second scale value from a second scale value set and, with the second scale value, performing a second scaling operation on the second polar coordinate values and the second pixel values based on the radial coordinate to generate a second scaled image, wherein the second scaled image comprises a plurality of second scaled pixels, and each of the second scaled pixels has a second scaled polar coordinate value of the polar coordinate system and a second scaled pixel value;
a code L for retrieving a plurality of second interest points from the second scaled pixels of the second scaled image by using a Corner Detection method, wherein each of the second interest points comprises a part of the second scaled pixels;
a code M for accumulating the second scaled pixel values of the second scaled pixels of each of the second interest points, based on the angular coordinate, to normalize the second scaled polar coordinate values of the second scaled pixels of each of the second interest points;
a code N for generating a second local description value set of each of the second interest points according to the second scaled polar coordinate values and the second scaled pixel values of the second scaled pixels of each of the second interest points;
a code O for storing the second local description value sets into a second database;
a code P for repeating execution of the code K through the code O by choosing another second scale value from the second scale value set to perform a second scaling operation with the another second scale value to generate a second local description value set of each of the second interest points corresponding to the another second scale value and store the second local description value set into the second database, until all the second scale values of the second scale value set have been chosen;
a code Q for intercomparing the first local description value sets of the first database with the second local description value sets of the second database to recognize a matching feature between the first image and the second image.

7. The computer program product as claimed in claim 6, wherein the first scale value set comprises n₁+n₂+1 first scale values, and the first scale values are 2⁻ⁿ^{₁} to 2ⁿ^{₂}, and wherein the second scale value set comprises m₁+m₂+1 second scale values, and the second scale values are 2⁻ⁿ^{₁} to 2ⁿ^{₂}.

8. The computer program product as claimed in claim 6, wherein the code E further comprises:
a code E1 for determining a first angle, based on the angular coordinate, corresponding to a greatest accumulated value of the first scaled pixel values of each of the first interest points; and
a code E2 for adjusting the first scaled polar coordinate values of the first scaled pixels of each of the first interest points, according to the first angle corresponding to each of the first interest points, to normalize the first scaled polar coordinate values;
and wherein the code M further comprises:
a code M1 for determining a second angle, based on the angular coordinate, corresponding to a greatest accumulated value of the second scaled pixel values of each of the second interest points; and
a code M2 for adjusting the second scaled polar coordinate values of the second scaled pixels of each of the second interest points, according to the second angle corresponding to each of the second interest points, to normalize the second scaled polar coordinate values.

9. The computer program product as claimed in claim 6, wherein the code E further comprises:
a code E3 for, before accumulating the first scaled pixel values, multiplying the first scaled pixel values of the first scaled pixels of each of the first interest points with a plurality of Gaussian weights;
and wherein the code M further comprises:
a code M3 for, before accumulating the second scaled pixel values, multiplying the second scaled pixel values of the second scaled pixels of each of the second interest points with the Gaussian weights.

10. The computer program product as claimed in claim 6, wherein the code F further comprises:
a code F1 for comparing the first scaled pixel values of the first scaled pixels of each of the first interest points to generate the first local description value set of each of the first interest points;
and wherein the code N further comprises:
a code N1 for comparing the second scaled pixel values of the second scaled pixels of each of the second interest points to generate the second local description value set of each of the second interest points.
